(19) United States
(12) Patent Application Publication
(10) Pub. No.: US 2007/0030331 A1
(43) Pub. Date: Feb. 8, 2007

(54) Releasable device for retaining a finger in the bottom of a notch

(75) Inventors: Anton Sutherland, Antony (FR); Patrick Darce, Montreuil Sous Bois (FR)

Correspondence Address: YOUNG & THOMPSON, 745 SOUTH 23RD STREET, 2ND FLOOR, ARLINGTON, VA, 22202, US

(73) Assignee: AXIOHM, MONTROUGE (FR)

(21) Appl. No.: 11/493,824

(22) Filed: Jul. 27, 2006

(30) Foreign Application Priority Data
Aug. 3, 2005 (FR) 05 08283

(51) Int. Cl. B41J 2/325; G01D 15/10

(52) U.S. Cl. 347/222

(57) ABSTRACT

A releasable device for retaining a finger against an abutment carried by a first structure element, which finger, carried by a second structure element can be moved perpendicularly to its own axis along a defined trajectory away from or towards the first structure element which includes a catch member capable in retractable manner of interfering with said trajectory above the abutment; the finger is received in an oblong slot of the second structure element that allows the finger a limited amount of movement relative to the second structure element along said trajectory.

The present invention relates to a releasable device for retaining a finger, e.g. secured to the lid of a box, in the bottom of a notch formed in the box.

### BACKGROUND OF THE INVENTION

There exist numerous openable units in which a lid is locked on a box or a frame in releasable manner. These units include openable thermal printers in which a frame carries a print head and defines a housing for a roll of thermally sensitive paper, and a lid or cover serves to give access to said housing in order to change the roll, with the capstan and the print head separating on opening in order to make it easy to insert the paper between them.

Closing the cover establishes contact between a row of hot points carried by the print head and the capstan, with the paper pinched between them. In some configurations, closure is locked by the contact force of the head against the capstan; in other configurations a separate latch is actuated for this purpose, with the drawback of it being necessary to move the latch before opening and after closing the cover. Although locking by means of the head is ensured merely by closing the cover, its drawback lies in the fact that it is not good at withstanding reversal of the paper drive direction. Under such circumstances, the rotation of the capstan tends to cause it to lose contact with the head.

### OBJECT OF THE INVENTION

The present invention proposes a device which retains the automatic nature of locking, which takes place merely by closing the cover, and which is likewise released merely by opening the cover, while ensuring that the capstan is held positively relative to the print head while the printer is in operation.

### BRIEF SUMMARY OF THE INVENTION

To this end, the invention thus provides more generally a releasable device for retaining a finger against an abutment carried by a first structure element, which finger, carried by a second structure element can be moved perpendicularly to its own axis along a defined trajectory away from or towards the first structure element, which includes a catch member capable of interfering, in retractable manner, with said trajectory above said abutment, the finger being received in an oblong slot of the second structure element that allows the finger a limited amount of movement relative to the second structure element along said trajectory.

This ability of the finger to move relative to the second element of the frame (e.g. a lid), constitutes the essential means enabling mere movement of the lid in one direction or the other to act mechanically to cause the catch above the abutment to be retracted before the finger reaches it, and before the finger leaves it.

In a first embodiment, the retractable catch member for interfering with the trajectory comprises a lever having a longitudinal direction, the lever being hinged at one end to the first structure element about an axis parallel to the axis of the finger and situated substantially below the abutment, and having at its end opposite to its hinge end a branch extending perpendicularly to the longitudinal direction of the lever and capable of crossing the trajectory when the lever is in a position towards which it is continuously urged by a resilient return member, the lever and the second structure element possessing co-operating cams whereby relative movement between the two structure elements causes the lever to tilt against the resilient return member.

More precisely, one of the cams is formed by the finger itself and the above-mentioned branch of the lever is surmounted by a cam for co-operating with said finger and possessing a sliding slope for the finger whereby the lever is moved away from the trajectory against the force of the return member during movement of the finger towards the abutment. Another cam is formed by a peg carried by the second structure element and the cam of the lever co-operating therewith comprises a slope at an angle of inclination relative to the direction of the trajectory, along which the peg slides in order to push the lever back against the force of the return member prior to the finger being moved away from the abutment.

In an embodiment of the invention applicable to the field of thermal printing, the abutment is constituted by the bottom of a notch formed in the first structure element of a printer and the catch member holds the finger captive in the notch substantially without clearance, which finger is the end of a stub axle of the capstan.

However, in preferred manner, in this application of the invention, the lever is formed by a side portion of cutout sheet metal extending perpendicularly to the capstan of a frame for the print head of the printer, the resilient return member being a member for returning the head against the capstan and the abutment is formed by an edge of a notch formed in the lever, the other edge of the notch constituting the above-mentioned catch member.

With this disposition, the position of the capstan relative to the row of hot points in the print head is determined accurately since the chain of dimensions to be mastered is short.

The surfaces of the cams of the lever result from suitably cutting out that edge of the frame of the print head which is turned towards the capstan.

The stub axle is received with substantially no clearance in the notch of the lever, while a brake is provided between the two structure elements so as to provide friction between them while the finger is in the notch.

In this embodiment, it is also possible to provide a notch in the first structure element that receives the stub axle and enables it to be guided better than solely by the oblong slot carrying it. In particular, it is useful for there to be at least one lateral bearing edge of the stub axle opposite from the print head to make available, here also, very precise positioning of the capstan relative to the print head, said edge belonging to the first structure element to which the head itself is hinged, so that the chain of dimensions connecting the capstan to the head is even shorter than when said edge is absent (its function then being performed by the oblong slot), the chain of dimensions then comprising the second structure element and its connection—e.g. a hinged connection—to the first structure element.

### BRIEF DESCRIPTION OF THE DRAWINGS

The invention can be better understood from the following description of embodiments thereof.

Reference is made to the accompanying drawings, in which:

FIGS. 1 to 4 are diagrams showing an embodiment of the invention and the principle on which it operates;

FIG. 5 is a diagrammatic side view of a thermal printer in accordance with the invention while it is being closed;

FIG. 6 is a fragmentary diagrammatic side view of the FIG. 5 printer in its closed state; and

FIG. 7 is a diagrammatic side view of a thermal printer in accordance with the invention while it is being opened.

### DETAILED DESCRIPTION OF THE INVENTION

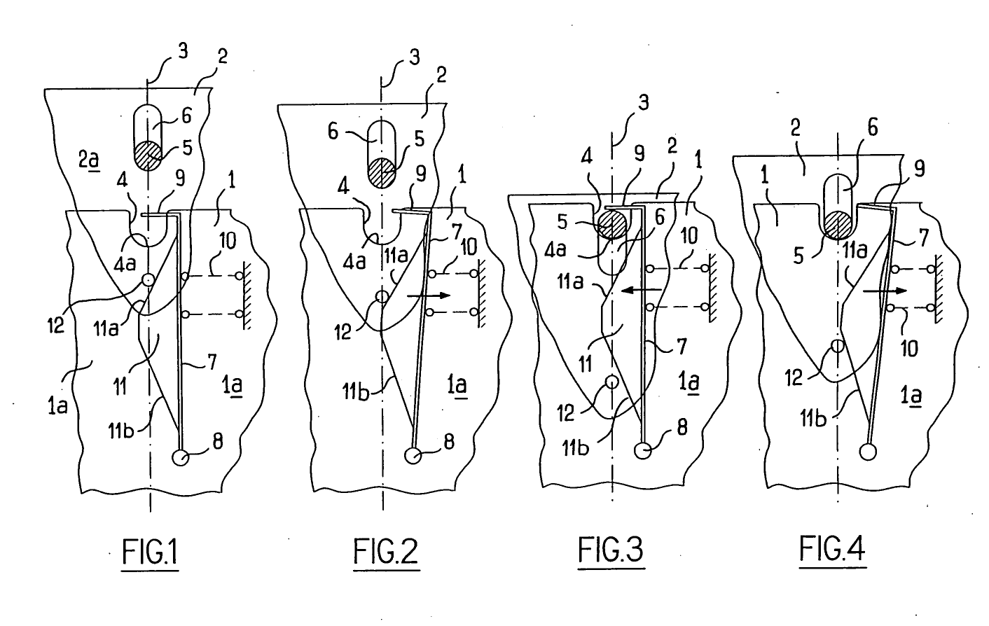

FIGS. 1 to 4 show two structure elements 1 and 2 that are movable relative to each other in a direction 3. This direction is shown in these figures as being rectilinear, but as a general rule it is circularly arcuate since the structure element 2 is usually hinged to the structure element 1 about an axis that is not shown. In any event, this axis is far enough away from the direction 3 for the corresponding circular arc of said direction to be considered as being a straight line. The structure element 2 may thus be the lid of a box forming the structure element 1.

The structure element 1 possesses a notch 4, e.g. in one of its side walls 1a. If the box element possesses another side wall parallel to the wall 1a, that other side wall may also have a notch such as the notch 4. The structure element 2 may be U-shaped, for example, with two side walls such as 2a sliding between the walls such as 1a when the structure element 2 is moved towards the structure element 1. The element 2 has a locking finger 5 floatingly mounted in an oblong slot 6 formed in the side walls such as 2a. This finger can be the end of a transverse shaft extending perpendicularly to the plane of the figure, projecting outside the side walls such as 2a of the structure element 2 so as to reach the bottom 4a of the notch 4. It will be understood that when the structure element 2 is moved along the direction 3, the finger 5, and thus the shaft of which it constitutes the end, moves perpendicularly to its axis.

A lever 7 is hinged via its end 8 to the structure element 1 about an axis that is parallel to the axis of the finger 5. At its end remote from the hinge 8, the lever possesses a branch at right angles 9 which, in a certain position of the lever, blocks the entrance to the notch 4. A spring 10 acts on the lever to urge it continuously towards a position in which it closes the entrance to the notch 4. An abutment (not shown) restricts the tilting of the lever 7 about its hinge 8 under drive from the spring 10. The lever includes a cam 11 having two slopes 11a and 11b. The angles of inclination of these slopes are such that a peg 12 secured to the structure element 2 can slide along the slope 11a when said element is moved towards the structure element 1 along the direction 3, thereby pushing back the lever 7 against the effect of the spring 10 and thus releasing the notch 4 of its catch 9.

FIG. 2 shows the instant when the two structure elements are coming together while the branch 9 is completely outside the notch 4. Continued sliding of the peg 12 over the cam 11 holds the lever 7 away from the notch 4, thus enabling the finger 5 to be received therein.

Once the finger 5 is in the notch, the lever 7 is pushed back towards the notch by the spring 10 since, as shown in FIG. 3, the structure element 2 continues to move towards the structure element 1. The peg 12 thus passes to the side of the inclined ramp 11b, while the slot 6 enables the finger 5 to remain stationary relative to the structure element 1. In this state, the finger 5 is locked so as to be incapable of escaping from the notch 4 should it be subjected to a force tending to move it out therefrom. The branch 9 of the lever 7 constitutes a clear abutment opposing such movements. In addition, the dimensions of the lever 7 are determined with reference to the relative positions of the hinge 8 and of the bottom 4a of the notch of the diameter of the finger 5, and of the distance between the branch 9 and the hinge 8, so that once locking occurs as shown in FIG. 3, the finger 5 is held by the branch 9 in the bottom of the groove 4 without slack and thus without any ability to move significantly. This holding of the finger in a precise position presents advantages that are explained below.

Contrary to a lifting force acting directly on the finger 5 and thus countered by the branch 9 of the lever 7, acting on the structure element 2 so as to move it away from the structure element 1 allows the peg 12 to co-operate with the slope 11b of the cam 11 forming part of the lever 7, thereby causing the lever 7 to tilt about the hinge 8 while the slot 6 ensures that the finger 5 is not moved since the frame element 2 is free to move along the length of the slot 6 independently of the finger 5. When the bottom end of the slot 6 comes into contact with the finger 5, the branch 9 of the lever 7 has been fully retracted from the opening of the notch 4 and the finger 5 can be extracted from the notch. FIG. 4 shows the instant when the end of the slot 6 comes into contact with the finger 5 at the moment the finger 5 begins to be extracted from the notch 4.

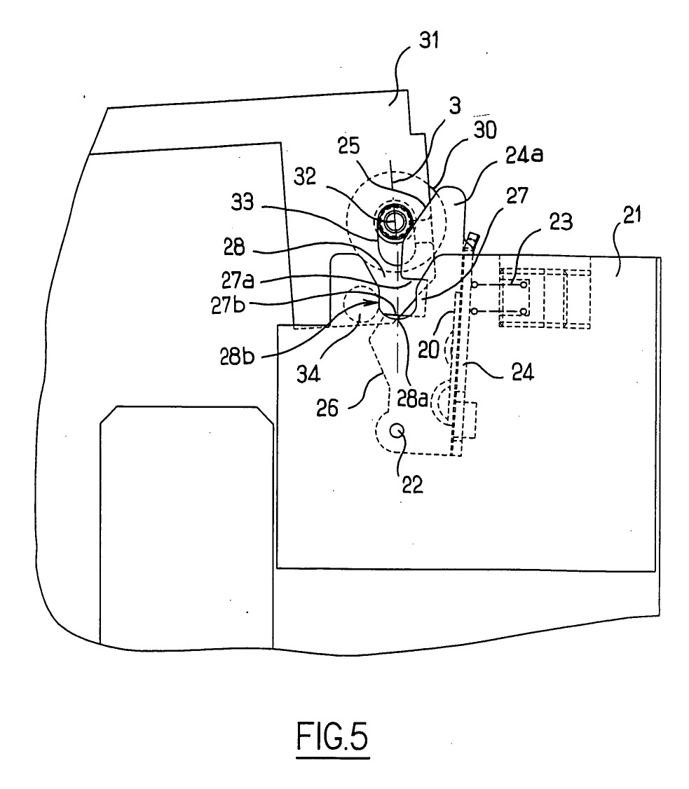

FIG. 5 is a side view of an openable thermal printer comprising in conventional manner a print head 20 hinged to a stationary structure 21 about an axis 22 and continuously urged to the left in the figure about the hinge axis 22 against an abutment (not shown) by a spring 23. The structure 21, of which only one side flank can be seen in the figure, is generally U-shaped and the print head 20 can pivot between the flanges of the U-shape, or more precisely the frame 24 carrying the print head can pivot between them. The flanges 24a of the frame carrying the hinge 22 form the above-described cam 11. The edges of these flanges present respective pairs of slopes 25 and 26 which are slopes similar to the slopes 11a and 11b described above. The flange 24a thus acts as the lever 7, and the top edge 27a of a notch 27 constitutes the branch 9 of the lever. It can be seen that the slope 25 is above the edge 27a of the notch 27 while the slope 26 is situated beneath the notch.

The printer shown has a lid 31 forming a support structure for a capstan 30 which is supported by said structure 31 by means of end stub axles 32. These end stub axles 32 are received in respective oblong slots 33 such that the lid 31, the stub axle 32, and the slots 33 are equivalent respectively to the structure element 2, the finger 5, and the oblong slot 6.

It should be observed in this figure that a notch 28 is provided in each of the two side walls of the stationary structure 21 of the printer, with the notch 28 in each wall presenting a bottom 28a which is shown in FIG. 5 as being under the edge 27a of the notch 27 in the flange 24a of the frame 24.

The lid 31 also has secured thereto a peg 34 situated below the stub axle 32 and offset to the left relative thereto so that the stub axle 34 does not come into contact with the flange 24a of the frame 24 while the lid is being closed.

During this closure movement, the stub axle 32 encounters the slope 25 of the flange 24a and pushes back the frame 24 so that it pivots about the hinge 22 against the force of the return spring 23. Once the stub axles 32 have gone beyond the edge 27a of the notch 27, the frame 24 can pivot in the opposite direction, with the stub axle 32 then being received inside the notch 27.

The stub axle 32 can reach the bottom 28a of the notch 28. The operation is then as described with reference to the preceding figures. However, in reality, a significant embodiment difference should be observed between the device shown in FIG. 5 and the device shown in the diagrams of FIGS. 1 to 4. In FIG. 5, the width of the notch 27 is equal to the diameter of the stub axle 32. In addition, the edge 27b of said notch that is opposite from the edge 27a is further away from the hinge 22 than the edge 28a constituting the bottom of the notch 28 formed in the stationary structure 21. Thus, the stub axle 22 is prevented from moving in the notch 28 by the notch 27 whose edge 27b performs the function of the edge 4a of the notch 4 in the above-described operation. This disposition is advantageous for a thermal printer since the notch 27 is made in the frame 24 that carries the print head 20 and thus the row of hot points for coming into contact with the capstan 30. It will be understood that by preventing the stub axle 32 from moving relative to the notch 27, the position of the generator line of the capstan 30 that comes in contact with the row of hot points on the head 20 is determined by means of a chain of dimensions that is very short. In the embodiment of FIGS. 1 to 4, the chain of dimensions would necessarily have passed through the hinge 22, and that would have increased considerably the lack of precision in the position of the capstan relative to the row of hot points.

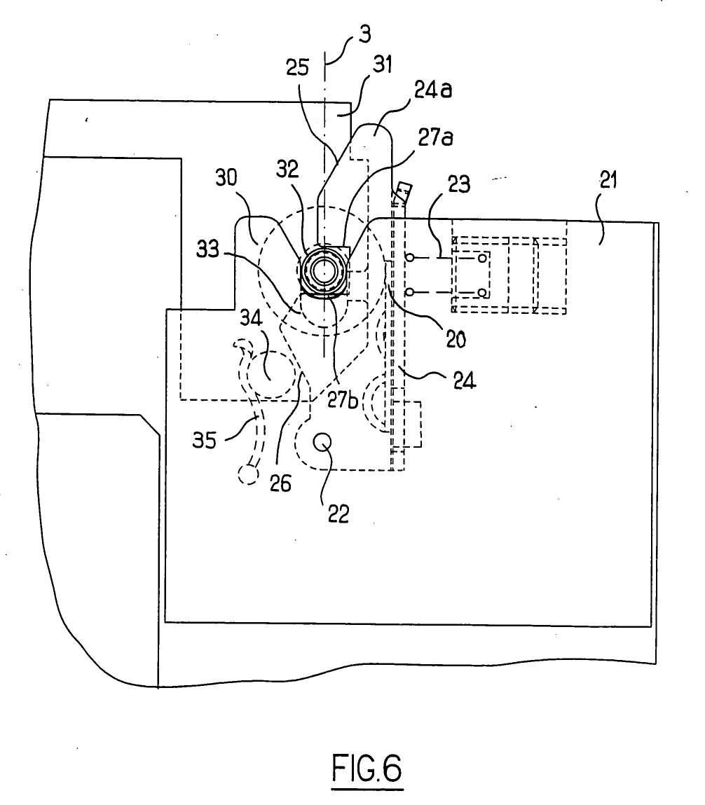

Thus, when the printer is fully closed, as shown in FIG. 6, the peg 34 is situated facing the slope 26 of the side flange 24a of the frame 24. It should be observed that the peg 34 (or any other stud secured to the lid 31) could equally well co-operate with a spring blade 35 carried by the structure 21 and constituting a brake for preventing any movement of the lid 31 relative to the capstan 30, which is held stationary in the notch 27.

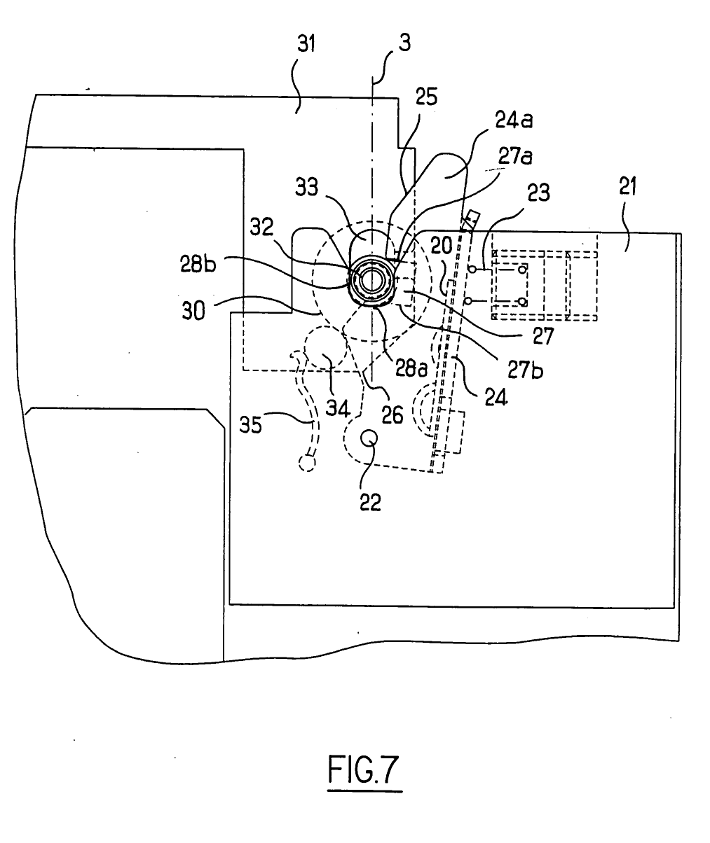

In FIG. 7, the device is shown while it is being opened. An operator acts on the lid 31, moving it in the direction for opening the printer, thereby firstly disengaging the peg 34 (the lid 31) from the spring 35, and secondly causing said peg 34 to co-operate with the slope 26 of the frame 24 so as to cause the frame to tilt clockwise about the hinge 22. The oblong slot 33 then travels along the stub axle 32 while the edge 27a of the notch 27 is progressively retracted together with the frame 24. When the bottom end of the slot 25 comes into contact with the stub axle 32, the stub axle has escaped fully from the notch 27 and can therefore be taken away with the lid 31. Since the stub axle 32 remains in contact with the edge of the flange 24a of the frame 24 it opposes any tilting back of the frame under drive from the spring 23.

The operator needs to do nothing more than act to open the printer, i.e. to move the lid 31 away from the structure 21. This action is as simple as that required on printers that are locked by the print head. In contrast, there are considerable improvements both in the force for keeping the printer closed and in the accuracy with which the relative positions of the capstan and the print head are maintained.

In a variant that is not shown, the notch 28 could be omitted. As described above, the bottom 28a does not serve as an abutment for the stub axle 32 during closure since this function is provided by the edge 27b of the notch 27. In addition, the stub axle 32 can be held in position laterally sufficiently by the edges of the oblong slot 33. However the existence of an edge such as the edge 28b carried by the structure 21 opposite from the print head 20 can but contribute to improving the precision with which the capstan 30 is positioned relative to the head 20.

What is claimed is:

1. A releasable device for retaining a finger against an abutment carried by a first structure element, which finger, carried by a second structure element can be moved perpendicularly to its own axis along a defined trajectory away from or towards the first structure element which includes a catch member capable in retractable manner of interfering with said trajectory above said abutment, wherein the finger is received in an oblong slot of the second structure element that allows the finger a limited amount of movement relative to the second structure element along said trajectory.

2. A device according to claim 1, wherein the retractable catch member for interfering with the trajectory comprises a lever having a longitudinal direction, the lever being hinged at one end to the first structure element about an axis parallel to the axis of the finger and situated substantially below the abutment, and having at its end opposite to its hinge end a branch extending perpendicularly to the longitudinal direction of the lever and capable of crossing the trajectory when the lever is in a position towards which it is continuously urged by a resilient return member, the lever and the second structure element possessing co-operating cams whereby relative movement between the two structure elements causes the lever to tilt against the resilient return member.

3. A device according to claim 2, wherein one of the cams is formed by the finger itself and the above-mentioned branch of the lever is surmounted by a cam for co-operating with said finger and possessing a sliding slope for the finger whereby the lever is moved away from the trajectory against the force of the return member during movement of the finger towards the abutment.

4. A device according to claim 3, wherein another cam is formed by a peg carried by the second structure element and the cam of the lever co-operating therewith comprises a slope at an angle of inclination relative to the direction of the trajectory, along which the peg slides in order to push the lever back against the force of the return member prior to the finger being moved away from the abutment.

5. A device according to claim 1, wherein the abutment is constituted by the bottom of a notch formed in the first structure element.

6. A device according to claim 5, wherein the catch member holds the finger captive in the notch substantially without clearance.

7. A device according to claim 2, wherein the finger is constituted by a stub axle of a thermal printer capstan, the lever being formed by a side portion of cutout sheet metal extending perpendicularly to the capstan of a frame for the print head of the printer, the resilient return member being a member for returning the head against the capstan and the abutment being formed by an edge of a notch formed in the lever, the other edge of the notch constituting the above-mentioned catch member.

8. A device according to claim 7, wherein the cam surfaces of the lever are the result of suitably cutting out that edge of the lever which faces towards the capstan.

9. A device according to claim 7, wherein the stub axle is received with substantially no clearance in the notch of the lever, while a brake is provided between the two structure elements so as to provide friction between them while the finger is in the notch.
